(19) United States
(12) Patent Application Publication
(10) Pub. No.: US 2024/0015392 A1
(43) Pub. Date: Jan. 11, 2024

(54) Kamera-Assistenzsystem

(71) Applicant: Arnold & Richter Cine Technik GmbH & Co. Betriebs KG, München (DE)

(72) Inventors: Tamara Seybold, München (DE); Christine Ajayi-Scheuring, Wien (AT); Michael Haubmann, Wien (AT)

(21) Appl. No.: 18/348,742

(22) Filed: Jul. 7, 2023

(30) Foreign Application Priority Data
Jul. 8, 2022 (DE) 10 2022 207 014.3

(51) Int. Cl. H04N 23/60; H04N 23/67; H04N 13/128; H04N 13/30; H04N 13/246; H04N 23/80

(52) U.S. Cl. CPC H04N 23/64; H04N 23/671; H04N 13/128; H04N 13/30; H04N 13/246; H04N 23/80; H04N 2013/0085

(57) ABSTRACT

Camera assistance system (1) comprising an image processing unit (2) which processes a camera image (KB) of a recording subject (AM) received from a camera (5) to generate a useful camera image (NKB), wherein the camera image (KB) received from the camera (5) is projected onto a virtual three-dimensional projection surface (PF), of which the height values correspond to a local imaging sharpness (AS) of the received camera image (KB); and comprising a display unit (3) which displays the camera image (KB) projected by the image processing unit (2) onto the virtual three-dimensional projection surface (PF).

The present invention relates to a camera assistance system and a method for assisting in the focusing of a camera with the aid of such a camera assistance system.

In the professional use of moving image cameras, the focusing of a camera lens of the moving image camera is typically not fully automatic, but at least partially manual. A main reason why the focusing of the camera lens is performed manually is that not all distance planes of the scenery located in the field of view of the camera lens and captured by the moving image camera should be imaged sharply. In order to direct a viewer's attention to a specific region, a sharply imaged distance region is emphasized over a blurred foreground or background. In order to manually focus the camera lens of the camera, a so-called follow focus device can be provided, with which a distance setting ring of the camera lens of the camera is actuated so that the focus is changed.

A camera generates a camera image which includes image information. If the image information can be used to distinguish many details within the scene captured by the camera, the camera image has a high degree of sharpness. Each camera lens of a camera can be focused to a specific distance. It is possible to image a plane in the captured scene sharply. This plane is also called the plane of focus. Parts of the recording subject located outside this plane of focus are imaged gradually in a more blurred manner as the distance from the plane of focus increases. The depth of field is a measure of the extent of a sufficiently sharp region in an object space of an imaging optical system. The depth of field which is also colloquially referred to as field depth is understood to be the extent of a region, in which the recorded camera image is perceived as sufficiently sharp.

When manually focusing the camera lens in order to set the plane of focus and the depth of field, the user can be assisted by an assistance system. In this case, conventional methods for sharpness indication can be used, which provide additional information along with the display of the camera image e.g. in a viewfinder or on a monitor. In the case of so-called focus peaking, a sharpness indication is effected by means of a contrast-based false color display of the captured camera image on a screen. In this case, the contrast at the object edges of the recording subject can be increased.

In conventional camera assistance systems, distance information can also be faded into a camera image or superimposed on the camera image in a dedicated overlay plane. By coloring pixels of the camera image, a color-coded two-dimensional overlay plane can be placed over the camera image. Furthermore, it is possible that edges of sharply imaged objects are marked in color.

In addition, conventional focusing-assistance systems are known, in which a frequency distribution of objects is displayed within a field of view of a camera in order to assist a user in manually focusing the camera lens.

A major disadvantage of such conventional camera assistance systems for assisting a user in focusing the camera lens of the camera is that either the image content of the camera image is superimposed with information, so that the actually captured camera image is visible to the user only to a limited extent, or that the displayed information is not intuitively comprehensible to the user. This makes manual focusing of the camera lens of the camera tedious and prone to error for the user.

Therefore, it is an object of the present invention to provide a camera assistance system for assisting a user in focusing a camera, in which the error rate in manual focusing of the camera lens is reduced.

This object is achieved by a camera assistance system having the features stated in claim 1.

Accordingly, the invention provides a camera assistance system having an image processing unit which processes a camera image of a recording subject received from a camera to generate a useful camera image, wherein the camera image received from the camera is projected onto a virtual three-dimensional projection surface, of which the height values correspond to a local imaging sharpness of the received camera image and having

a display unit which displays the camera image projected by the image processing unit onto the virtual three-dimensional projection surface.

With the aid of the camera assistance system in accordance with the invention, manual focusing of a camera lens of the camera can be effected more rapidly and with greater precision.

Advantageous embodiments of the camera assistance system in accordance with the invention are apparent from the dependent claims.

In one possible embodiment of the camera assistance system in accordance with the invention, the local imaging sharpness of the received camera image is determined by means of an imaging sharpness detection unit of the camera assistance system.

This allows the camera assistance system in accordance with the invention to also be used in systems which do not have a depth measuring unit for generating a depth map.

In one possible embodiment of the camera assistance system in accordance with the invention, the imaging sharpness detection unit of the camera assistance system has a contrast detection unit or a phase detection unit.

In one possible embodiment of the camera assistance system in accordance with the invention, the imaging sharpness detection unit of the camera assistance system calculates the local imaging sharpness of the received camera image in dependence upon at least one focus metric.

The possible use of different focus metrics makes it possible to configure the camera assistance system for different applications.

In one possible embodiment of the camera assistance system in accordance with the invention, the imaging sharpness detection unit calculates the imaging sharpness of the received camera image using a contrast value-based focus metric on the basis of ascertained local contrast values of the unprocessed camera image received from the camera and/or on the basis of ascertained local contrast values of the processed useful camera image generated therefrom by the image processing unit.

In one possible embodiment of the camera assistance system in accordance with the invention, the imaging sharpness detection unit of the camera assistance system ascertains the local contrast values of the two-dimensional camera image received from the camera and/or of the two-dimensional useful camera image generated therefrom, in each case for individual pixels of the respective camera image or in each case for a group of pixels of the respective camera image.

In a further possible embodiment of the camera assistance system in accordance with the invention, the camera image received from the camera is filtered by a spatial frequency filter.

This filtering can reduce fragmentation of the camera image which is displayed on the display unit and projected onto the virtual projection surface.

In a further possible embodiment of the camera assistance system in accordance with the invention, the image processing unit calculates a stereo image pair which is displayed on a 3D display unit of the camera assistance system.

The stereo image pair is calculated preferably on the basis of the camera image, which is projected onto the virtual three-dimensional projection surface, by means of the image processing unit of the camera assistance system.

The three-dimensional illustration with the aid of the 3D display unit facilitates the intuitive focusing of the camera lens of the camera by the user.

In an alternative embodiment of the camera assistance system in accordance with the invention, the image processing unit calculates a pseudo-3D illustration with artificially generated shadows or an oblique view on the basis of the camera image projected onto the virtual three-dimensional projection surface, which illustration is displayed on a 3D display unit of the camera assistance system.

In this embodiment, the intuitive operability is likewise facilitated when focusing the camera lens of the camera without the camera assistance system having to have a 3D display unit.

In a further possible embodiment of the camera assistance system in accordance with the invention, the height values of the virtual three-dimensional projection surface generated by the image processing unit correspond to a calculated product of an ascertained local contrast value of the unprocessed camera image received from the camera and a settable scaling factor.

In this manner, the user has the option of setting or adjusting the depth or height of the virtual three-dimensional projection surface for the respective application.

In a further possible embodiment of the camera assistance system in accordance with the invention, the useful camera image generated by the image processing unit is stored in an image memory of the camera assistance system.

This facilitates transmission of the useful camera image and allows further local image processing of the generated useful camera image.

In a further possible embodiment of the camera assistance system in accordance with the invention, the image processing unit executes a recognition algorithm for recognizing significant object parts of the recording subject contained in the received camera image and requests corresponding image sections within the camera image with increased resolution from the camera via an interface.

As a result, manual focusing of the camera lens of the camera with increased precision is possible.

In a further possible embodiment of the camera assistance system in accordance with the invention, the camera assistance system has at least one depth measuring unit which provides a depth map which is processed by the image processing unit in order to generate the virtual three-dimensional projection surface.

In one possible embodiment of the camera assistance system in accordance with the invention, the depth measuring unit of the camera assistance system is suitable for measuring an instantaneous distance of recording objects, in particular of the recording subject, from the camera by measuring a running time or by measuring a phase shift of ultrasonic waves or of electromagnetic waves, and for generating a corresponding depth map.

In one possible embodiment of the camera assistance system in accordance with the invention, the depth measurement unit has at least one sensor for detecting electromagnetic waves, in particular light waves, and/or a sensor for detecting sonic waves, in particular ultrasonic waves.

In one possible embodiment of the camera assistance system in accordance with the invention, the sensor data generated by the sensors of the depth measuring unit are fused by a processor of the depth measuring unit in order to generate the depth map.

By fusing sensor data, it is possible to increase the quality and accuracy of the depth map which is used for projection of the camera image.

In a further possible embodiment of the camera assistance system in accordance with the invention, the depth measuring unit of the camera assistance system has at least one optical camera sensor for generating one or more depth images which are processed by a processor of the depth measuring unit in order to generate the depth map.

In one possible embodiment of the camera assistance system in accordance with the invention, a stereo image camera is provided which has optical camera sensors for generating stereo camera image pairs which are processed by the processor of the depth measuring unit in order to generate the depth map.

In a further possible embodiment of the camera assistance system in accordance with the invention, the image processing unit has a depth map filter for multidimensional filtering of the depth map provided by the depth measuring unit.

In a further possible embodiment of the camera assistance system in accordance with the invention, the camera assistance system has an adjustment unit for setting recording parameters of the camera.

In one possible embodiment of the camera assistance system in accordance with the invention, the recording parameters which can be set by means of the setting unit of the camera assistance system comprise a focus position, an iris diaphragm opening and a focal length of a camera lens of the camera, as well as an image recording frequency and a shutter speed.

In a further possible embodiment of the camera assistance system in accordance with the invention, the image processing unit receives via an interface the focus position set by means of the setting unit of the camera assistance system and superimposes this as a semitransparent plane of focus on the camera image, which is projected onto the virtual three-dimensional projection surface, for display thereof on the display unit of the camera assistance system.

By changing the focus setting or focus position, this plane of focus can be shifted in depth by the user by means of the setting unit, wherein a correct focus setting can be effected on the basis of the overlaps with the recording subject contained in the camera image.

In a further possible embodiment of the camera assistance system in accordance with the invention, a viewpoint on the camera image which is projected onto the virtual three-dimensional projection surface and is displayed on the display unit of the camera assistance system can likewise be set.

In one possible embodiment of the camera assistance system in accordance with the invention, the semitransparent plane of focus intersects a focus scale which is displayed on an edge of the display unit of the camera assistance system.

This additionally facilitates the manual focusing of the camera subject onto the plane of focus.

In a further possible embodiment of the camera assistance system in accordance with the invention, the image processing unit ascertains an instantaneous depth of field on the basis of a set iris diaphragm opening, a set focus position and optionally a set focal length of the camera lens of the camera.

In one possible embodiment of the camera assistance system in accordance with the invention, the image processing unit superimposes a semitransparent plane for illustrating a rear limit of a depth of field and a further semitransparent plane for illustrating a front limit of the depth of field on the camera image projected onto the virtual three-dimensional projection surface, in order to be displayed on the display unit of the camera assistance system.

This facilitates the manual focusing of the camera lens onto subject parts of the recording subject within the depth of field.

In a further possible embodiment of the camera assistance system in accordance with the invention, the image processing unit of the camera assistance system performs a calibration on the basis of the depth map provided by the depth measuring unit and on the basis of the camera image obtained from the camera, said calibration taking into account the relative position of the depth measuring unit to the camera.

This can increase the measuring accuracy of the depth measuring unit for generating the depth map and thus the accuracy during manual focusing.

In a further possible embodiment of the camera assistance system in accordance with the invention, the image processing unit ascertains a movement vector and a future position of the recording subject within a camera image, which is received from the camera, on the basis of the depth maps provided by the depth measuring unit over time, and derives therefrom a change in the local imaging sharpness of the received camera image.

By means of this pre-calculation, it is possible to compensate for delays which are caused by the measurement and processing of the camera image.

The invention further provides a camera having a camera assistance system for assisting in the focusing of the camera having the features stated in claim 30.

Accordingly, the invention provides a camera having a camera assistance system for assisting in the focusing of the camera,
wherein the camera assistance system has:
an image processing unit which processes a camera image of a recording subject received from a camera to generate a useful camera image, wherein the camera image received from the camera is projected onto a virtual three-dimensional projection surface, of which the height values correspond to a local imaging sharpness of the received camera image and
a display unit which displays the camera image projected by the image processing unit onto the virtual three-dimensional projection surface.

In one possible embodiment of the camera in accordance with the invention, the camera is a moving image camera.

In an alternative embodiment of the camera in accordance with the invention, the camera is a fixed image camera.

The invention further provides a method for assisting in the focusing of the camera having the features stated in claim 32.

Accordingly, the invention provides a method for assisting in the focusing of a camera including the steps of:
receiving a camera image of a recording subject by an image processing unit from the camera,
projecting the received camera image by the image processing unit onto a virtual three-dimensional projection surface, of which the height values correspond to a local imaging sharpness of the received camera image, and
displaying the camera image, which is projected on the virtual three-dimensional projection surface, on a display unit.

In one possible embodiment of the method in accordance with the invention, the imaging sharpness of the received camera image is calculated in dependence upon a focus metric.

In one possible embodiment of the method in accordance with the invention, the local imaging sharpness is calculated using a contrast value-based focus metric on the basis of ascertained local contrast values of the unprocessed camera image received from the camera and/or on the basis of ascertained local contrast values of the processed useful camera image generated therefrom by an image processing unit and is then multiplied by a settable scaling factor in order to calculate the height values of the virtual three-dimensional projection surface.

In an alternative embodiment of the method in accordance with the invention, the virtual three-dimensional projection surface is generated on the basis of a depth map which is provided by a depth measuring unit.

Possible embodiments of the camera assistance system in accordance with the invention and of the camera in accordance with the invention and of the inventive method for assisting in the focusing of a camera are explained in more detail hereinafter with reference to the attached figures.

In the drawing:

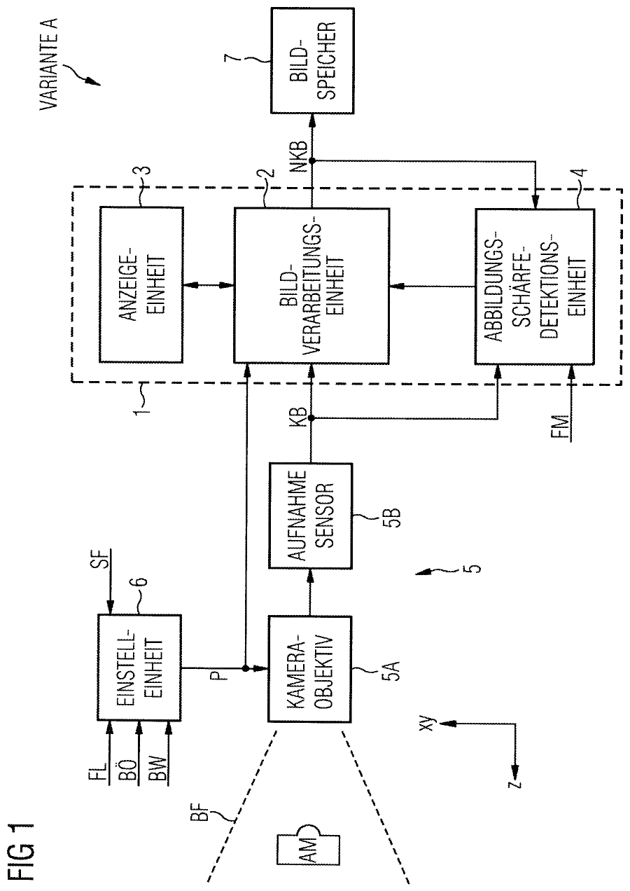

FIG. 1 shows a block diagram to illustrate one possible embodiment of the camera assistance system in accordance with the invention;

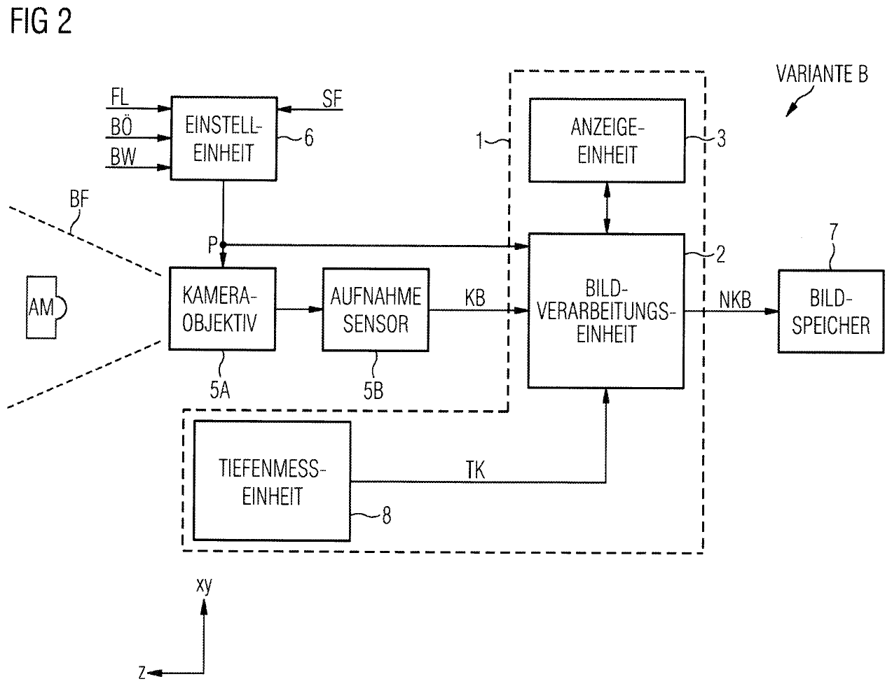

FIG. 2 shows a block diagram to illustrate a further possible embodiment of the camera assistance system in accordance with the invention;

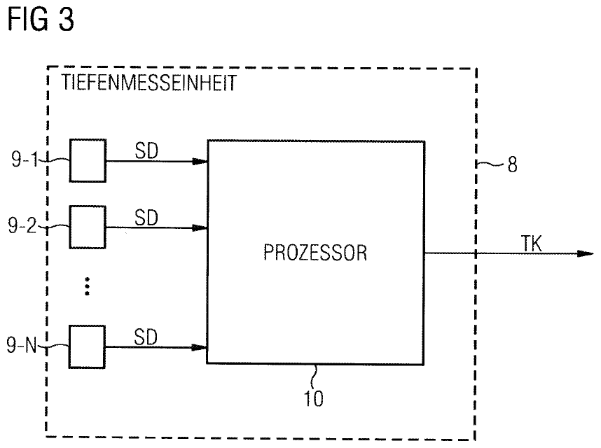

FIG. 3 shows a simple block diagram to illustrate one possible implementation of a depth measuring unit of the camera assistance system illustrated in FIG. 2;

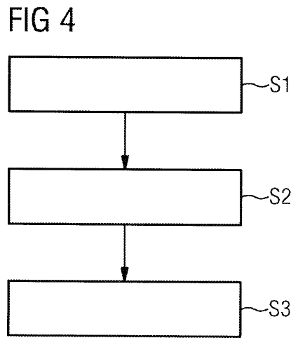

FIG. 4 shows a flow diagram illustrating one possible embodiment of the inventive method for assisting in the focusing of a camera;

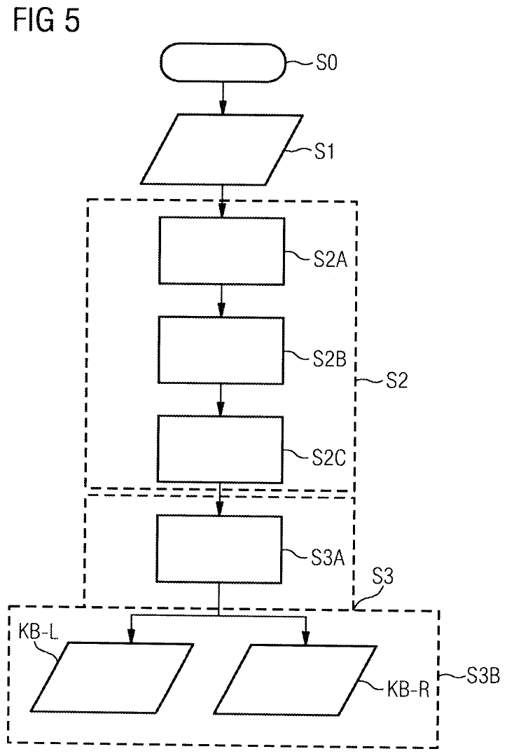

FIG. 5 shows a further flow diagram illustrating an embodiment of the method for assisting in the focusing of a camera, as illustrated in FIG. 4;

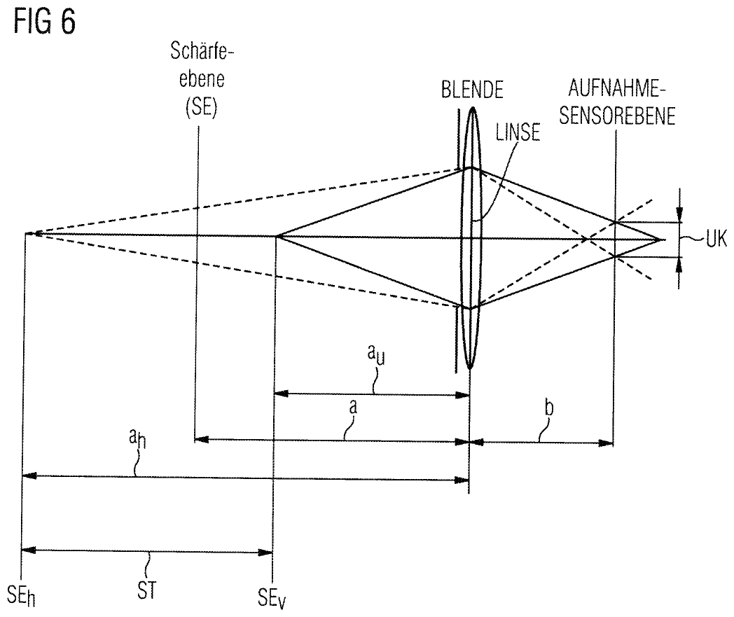

FIG. 6 shows a diagram for explaining the mode of operation of one possible embodiment of the camera assistance system in accordance with the invention;

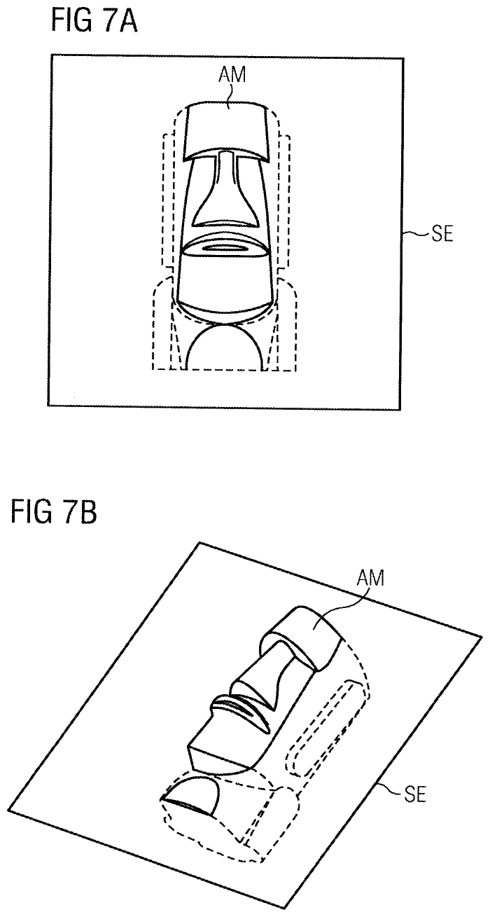

FIGS. 7A, 7B show examples for explaining a display of a plane of focus of one possible embodiment of the camera assistance system in accordance with the invention;

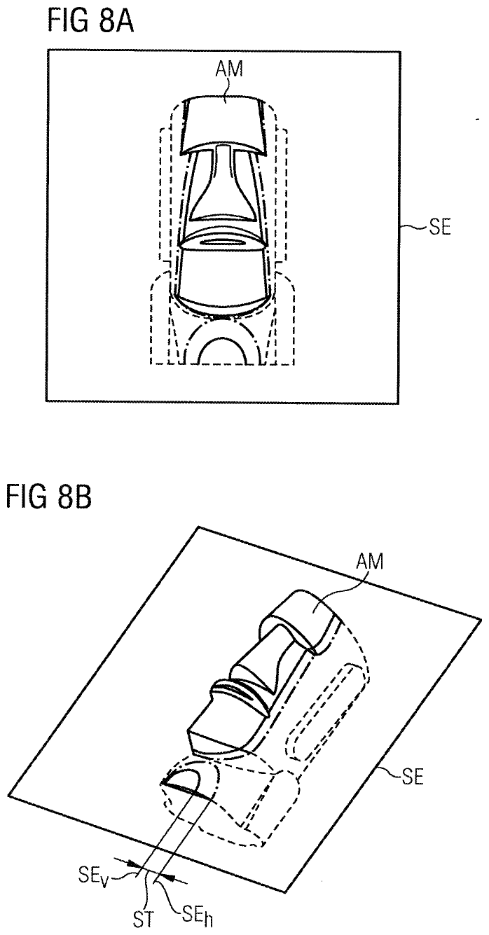

FIGS. 8A, 8B show a display of a plane of focus of one possible embodiment of the camera assistance system in accordance with the invention.

FIG. 1 shows a block diagram to illustrate one possible embodiment of a camera assistance system 1 in accordance with the invention. The camera assistance system 1 illustrated in FIG. 1 can be integrated in a camera 5 or can form a separate unit inside the camera system. In the exemplified embodiment illustrated in FIG. 1, the camera assistance system 1 has an image processing unit 2 and a display unit 3. The image processing unit 2 of the camera assistance system 1 can be part of an image processing system of a camera or of a camera system. Alternatively, the camera assistance system 1 can have a dedicated image processing unit 2.

The image processing unit 2 of the camera assistance system 1 obtains a camera image KB, as illustrated in FIG. 1. The image processing unit 2 generates from the received camera image KB a useful camera image NKB which can be stored in an image memory 7. The image processing unit 2 obtains the unprocessed camera image KB from a camera 5. This camera 5 can be a moving image camera or a fixed image camera. The camera assistance system 1 in accordance with the invention is suitable in particular for assisting in the focusing of a camera lens of a moving image camera. The image processing unit 2 of the camera assistance system 1 projects the camera image KB received from the camera 5 onto a virtual three-dimensional projection surface PF, of which the height values correspond to a local imaging sharpness AS of the camera image KB received from the camera 5. Furthermore, the camera assistance system 1 has a display unit 3 which displays to a user the camera image KB projected by the image processing unit 2 of the camera assistance system 1 onto the virtual three-dimensional projection surface PF.

The virtual projection surface PF is a data set generated by computing operations. The virtual projection surface PF is three-dimensional and not two-dimensional, i.e. the virtual projection surface PF used for the projection of the camera image KB is curved, wherein its z-values or height values correspond to a local imaging sharpness of the camera image KB, which is generated by the camera, comparable to a cartographic illustration of a mountain range. The virtual projection surface forms a 3D relief map which reproduces topographical conditions or the three-dimensional shape of the environment, in particular the recording subject AM, illustrated in the camera image KB. The elevations within the virtual 3D projection surface PF can be exaggerated by a scaling factor SF to render the relationship of different peaks and valleys within the virtual 3D projection surface PF clearer to the viewer. The virtual 3D projection surface PF consists of surface points pf with three coordinates pf (x,y,z), wherein the x-coordinates and the y-coordinates of the surface points pf of the virtual 3D projection surface PF correspond to the x-coordinates and y-coordinates of the pixels p of the camera image KB generated by the camera 5 and the z-coordinates or height values of the surface points pf of the virtual 3D projection surface correspond to the ascertained local imaging sharpness AS of the camera image KB at this position or in this local region of the camera image KB: (pf (x, y, AS)). The local region within the camera image KB can be formed by a group of pixels p arranged in a square within the camera image KB, e.g. 3×3=9 pixels or 5×5 pixels=25 pixels.

The calculation of the surface points pf of the virtual projection surface PF can be effected in real time using relatively small computing resources of the image processing unit 2, since no mathematically complex computing operations, such as feature recognition, translation or rotation, have to be performed for this purpose.

As shown in FIG. 1, the camera 5 substantially comprises a camera lens 5A and a recording sensor 5B. The camera lens 5A detects a recording subject AM which is located in the field of view BF of the camera lens 5A. Various recording parameters P can be set by means of a setting unit 6 of the camera assistance system 1. In one possible embodiment, these recording parameters P can also be supplied to the image processing unit 2 of the camera assistance system 1, as illustrated schematically in FIG. 1.

In the embodiment illustrated in FIG. 1, the image processing unit 2 obtains the local imaging sharpness AS of the camera image KB by means of an imaging sharpness detection unit 4 of the camera assistance system 1. In one possible embodiment, the imaging sharpness detection unit 4 of the camera assistance system 1 has a contrast detection unit for ascertaining image contrasts. In an alternative embodiment, the imaging sharpness detection unit 4 can also have a phase detection unit.

In one possible embodiment of the camera assistance system 1 illustrated in FIG. 1, the imaging sharpness detection unit 4 calculates the local imaging sharpness AS of the received camera image KB in dependence upon at least one focus metric FM. The imaging sharpness detection unit 4 can calculate the local imaging sharpness AS of the received camera image KB using a contrast value-based focus metric FM on the basis of ascertained local contrast values of the unprocessed camera image KB received from the camera 5 and/or on the basis of ascertained local contrast values of the processed useful camera image NKB generated therefrom by the image processing unit 2.

In one possible embodiment, the imaging sharpness detection unit 4 thus ascertains the local imaging sharpness AS of the received camera image KB by processing the unprocessed camera image KB itself and by processing the useful camera image NKB which is generated therefrom and is stored in the image memory 7. Alternatively, the imaging sharpness detection unit 4 can calculate the local imaging sharpness AS solely on the basis of the unprocessed camera image KB received by the imaging sharpness detection unit 4 from the camera 5, using the predefined contrast value-based focus metric FM. In one possible embodiment, the imaging sharpness detection unit 4 of the camera assistance system 1 ascertains the local contrast values of the two-dimensional camera image KB received from the camera 5 and/or of the two-dimensional useful camera image NKB generated therefrom, in each case for individual pixels of the respective camera image KB/NKB. Alternatively, the imaging sharpness detection unit 4 can ascertain the local contrast values of the two-dimensional camera image KB received from the camera 5 and the two-dimensional useful camera image NKB generated therefrom, in each case for a group of pixels of the camera image KB or useful camera image NKB. The local contrast values of the camera image KB can thus be ascertained pixel by pixel or for specified pixel groups.

In one possible embodiment, the recording sensor 5B of the camera 5 can be formed by a CCD or CMOS image converter, of which the signal output is connected to the signal input of the image processing unit 2 of the camera assistance system 1.

In one possible embodiment of the camera assistance system 1 in accordance with the invention, the digital camera image KB received from the camera 5 is filtered by a spatial frequency filter. This can reduce fragmentation of the camera image KB which is displayed on the display unit 3 and projected onto the virtual projection surface PF. The spatial frequency filter is preferably a low-pass filter. In order to prevent excessive fragmentation, there is the possibility of two-dimensional filtering which can be set, so that the virtual projection surface is formed more harmoniously. The image displayed on the display unit 3 thus acquires a three-dimensional structure in the region of the depth of field ST. In order to optimize contrast recognition, the camera assistance system 1 can also consider an image with a high dynamic range in addition to the processed useful camera image NKB in order to reduce quantization and limiting effects. Such quantization and limiting effects lead to the reduction in the image quality of the generated useful camera image NKB in dark and bright regions. The image with a high contrast range can be provided as a camera image KB of the imaging sharpness detection unit 4 in addition to the processed useful camera image NKB. The image processing unit 2 can then also generate, in addition to an image with a high dynamic range, a useful camera image NKB with a desired dynamic range which is converted to the corresponding color space. The image processing unit 2 can obtain the information (LUT, color space) required for this purpose from the camera 5 via a data communication interface. Alternatively, this information can be set on the device by a user.

The camera assistance system 1 has a display unit 3, as illustrated in FIG. 1. In one possible embodiment, the display unit 3 is a 3D display unit which is formed e.g. by means of a stereo display with corresponding 3D glasses (polarizing filter, shutter or anaglyph) or by means of an autostereoscopic display. In one possible embodiment, the image processing unit 2 can calculate a stereo image pair on the basis of the camera image KB projected onto the virtual three-dimensional projection surface PF, said stereo image pair being displayed to a user on the 3D display unit 3 of the camera assistance system 1.

If no 3D display unit 3 is available, in one possible embodiment the image processing unit 2 can calculate a pseudo 3D illustration with artificially generated shadows on the basis of the camera image KB projected onto the virtual three-dimensional projection surface PF, said pseudo 3D illustration being displayed on a 2D display unit 3 of the camera assistance system 1. Alternatively, an oblique view can also be calculated by means of the image processing unit 2, said oblique view being displayed on a 2D display unit 3 of the camera assistance system 1. The oblique view of a recording subject AM located in space within a camera image KB enables the user to recognize elevations more easily.

In one possible embodiment of the camera assistance system 1 in accordance with the invention, the display unit 3 is interchangeable for various application purposes. The display unit 3 is connected to the image processing unit 2 via a simple or bidirectional interface. In a further possible implementation, the camera assistance system 1 has a plurality of different interchangeable display units 3 for different application purposes. In one possible embodiment, the display unit 3 can have a touch-screen for user inputs.

In one possible embodiment of the camera assistance system 1 in accordance with the invention, the display unit 3 is connected to the image processing unit 2 via a wired interface. In an alternative embodiment, the display unit 3 of the camera assistance system 1 can also be connected to the image processing unit 2 via a wireless interface. Furthermore, in one possible embodiment, the display unit 3 of the camera assistance system 1 can be integrated with the setting unit 6 for setting the recording parameters P in a portable device. This allows free movement of the user, e.g. the camera assistant, during the focusing of the camera lens 5A of the camera 5. With the aid of the setting unit 6, the user has the option of setting various recording parameters P. The setting unit 6 allows the user to set a focus position FL, an iris diaphragm opening BÖ of a diaphragm of the camera lens 5A, and a focal length BW of the camera lens 5A of the camera 5. Furthermore, the recording parameters P which are set by a user with the aid of the setting unit 6 can include an image recording frequency and a shutter speed. The recording parameters P are supplied preferably also to the image processing unit 2, as illustrated schematically in FIG. 1.

In one possible embodiment, the camera lens 5A is an interchangeable camera lens or an interchangeable lens. In one possible implementation, the camera lens 5A can be set with the aid of lens rings. An associated lens ring can be provided for the focus position FL, the iris diaphragm opening BÖ and for the focal length BW. In one possible implementation, each lens ring of the camera lens 5A of the camera 5 which is provided for a recording parameter P can be set by means of an associated lens actuator motor which receives a control signal from the setting unit 6. The setting unit 6 is connected to the lens actuator motors of the camera lens 5A via a control interface. This control interface can be a wired interface or a wireless interface. The lens actuator motors can also be integrated in the housing of the camera lens 5A. Such a camera lens 5A can then also be adjusted exclusively via the control interface. In such an implementation, lens rings are not required for adjustment purposes.

The depth of field ST depends upon various recording parameters P. The depth of field ST is influenced by the recording distance a, i.e. the distance between the camera lens 5A and the recording subject AM. The further away the recording subject AM or the camera object, the greater the depth of field ST. Furthermore, the depth of field ST is influenced by the focal length BW of the camera optics. The shorter the focal length BW of the camera optics of the camera 5, the greater the depth of field ST. At the same recording distance, a large focal length BW has a low depth of field ST and a small focal length BW has a high depth of field ST. Furthermore, the depth of field ST depends upon the diaphragm opening BÖ of the camera lens 5A. The diaphragm controls how far the aperture of the camera lens 5A of the camera 5 is opened. The further the aperture of the camera lens 5A is opened, the more light falls upon the recording sensor 5B of the camera 5. The recording sensor 5B of the camera 5 requires a specific amount of light in order to illustrate all regions of the scenery located in the field of view BF of the camera 5 with high contrast. The larger the selected diaphragm opening BÖ (i.e. small f-number k), the more light falls upon the recording sensor 5B of the camera 5. Conversely, less light passes onto the recording sensor 5B when the diaphragm opening BÖ of the camera lens 5A is closed. A small diaphragm opening BÖ (i.e. a high f-number k) results in a high depth of field ST. A further factor influencing the depth of field ST is the sensor size of the recording sensor 5B. The depth of field ST thus depends upon various recording parameters P which for the most part can be set by means of the setting unit 6. The depth of field ST is influenced by the choice of focal length BW, the distance setting or focus position FL and by the diaphragm opening BÖ. The larger the diaphragm opening BÖ (small f-number k), the lower the depth of field ST (and vice-versa). When setting the distance (focusing) on a close object or close recording subject AM, the object space optically detected as sharp is shorter than when focusing on a more distant object.

In one possible embodiment, the image processing unit 2 receives via a further control interface the focus position FL set by means of the setting unit 6 of the camera assistance system 1 and superimposes this as a semitransparent plane of focus SE on the camera image KB, which is projected onto the virtual three-dimensional projection surface PF, for display on the display unit 3 of the camera assistance system 1. In one possible embodiment, the illustrated semitransparent plane of focus SE intersects a focus scale which is displayed on an edge of the display unit 3 of the camera assistance system 1. The illustration of a semi-transparent plane of focus SE on the display unit 3 is described in greater detail with reference to FIGS. 7A, 7B.

In a further possible embodiment of the camera assistance system 1 in accordance with the invention, the image processing unit 2 can also ascertain an instantaneous depth of field ST on the basis of a set iris diaphragm opening BÖ, the set focus position FL and optionally the set focal length BW of the camera lens 5A of the camera 5. The depth of field ST indicates the distance range, at which the image is sharply imaged. Objects or object parts which are located in front of or behind the plane of focus SE are imaged in a blurred manner. The further away the objects or object parts are from the plane of focus SE, the more blurred these areas are illustrated. However, within a certain range this blurring is so weak that a viewer of the camera image KB cannot perceive it. The closest and furthest points which are still within this allowable range form the limit of the depth of field ST. In one possible embodiment, the image processing unit 2 superimposes a semitransparent plane for illustrating the rear limit of the depth of field ST and a further semitransparent plane for illustrating a front limit of the depth of field ST on the camera image KB projected onto the virtual three-dimensional projection surface PF, in order to be displayed on the display unit 3 of the camera assistance system 1, as also illustrated in FIGS. 8A, 8B.

In one possible embodiment of the camera assistance system 1 in accordance with the invention, the image processing unit 2 receives a type of the camera lens 5A of the camera 5 used via an interface. From an associated stored depth of field table of the camera lens type of the camera lens 5A, the image processing unit 2 can ascertain the instantaneous depth of field ST on the basis of the set iris diaphragm opening BÖ, the set focus position FL and optionally the set focal length BW of the camera lens 5A. Alternatively, a user can also enter a type of the instantaneously used camera lens 5A via a user interface, in particular the setting unit 6.

In a further possible embodiment of the camera assistance system 1 in accordance with the invention, the image processing unit 2 can execute a recognition algorithm for recognizing significant object parts of the recording subject AM contained in the received camera image KB and can request corresponding image sections within the camera image KB with increased resolution from the camera 5 via an interface. As a result, the data volume can be kept low during image transmission. Furthermore, the request for image sections is provided in the case of applications, in which the sensor resolution of the recording sensor 5B of the camera 5 exceeds the monitor resolution of the display unit 3. In this case, the image processing unit 2 can request image sections containing significant object parts or objects (e.g. faces, eyes, etc.) pixel by pixel from the camera 5 as image sections in addition to the entire camera image KB which usually has a reduced resolution. In one possible embodiment, this can be effected via a bidirectional interface, in particular a standardized network interface.

In one possible embodiment of the camera assistance system 1 in accordance with the invention, the imaging sharpness detection unit 4 calculates the local imaging sharpness AS of the received camera image KB in dependence upon at least one focus metric FM. In one possible embodiment, this focus metric FM can be stored in a configuration memory of the camera assistance system 1.

The camera image KB generated by the recording sensor 5B of the camera 5 can comprise an image size of M×N pixels p. Each pixel p can be provided with an associated color filter in order to detect color information, and so an individual pixel p only receives in each case light with a main spectral component, e.g. red, green or blue. The local distribution of the respective color filters to the individual pixels p corresponds according to a regular and known pattern. Knowledge of the filter properties as well as the arrangement thereof makes it possible to calculate for each pixel p (x, y) of the two-dimensional camera image KB, in addition to the detected value corresponding to the color of the color filter, also the values corresponding to the other colors, and moreover by interpolating the values from adjacent pixels. Similarly, a luminescence or gray scale value can be ascertained for each pixel p (x, y) of the two-dimensional camera image KB. The pixels p of the camera image KB each have a position within the two-dimensional matrix, specifically a horizontal coordinate x and a vertical coordinate y. The local imaging sharpness AS of a group of pixels p within the camera image KB can be calculated by means of the image sharpness detection unit 4 corresponding to a predefined focus metric FM in real time on the basis of derivatives, on the basis of statistical values, on the basis of correlation values and/or by means of data compression depending on the gray scale values of the group of pixels p within the camera image KB.

For example, an imaging sharpness value AS according to one possible focus metric FM can be calculated by summing the squares of horizontal first derivative values of the gray scale values f(x, y) of the pixels p (x,y) of the camera image KB as follows:

Σₓ₌₀^{M-1}Σ_{y=0}^{N-3}(f(x,y+2)−f(x,y))²

Alternatively, a gradient of the first derivative values of the gray scale values in the vertical direction can also be calculated in order to ascertain the local imaging sharpness value AS of the pixel group corresponding to a correspondingly defined focus metric FM. Furthermore, the square values of the gradients of the gray scale values in the horizontal direction and/or in the vertical direction can be used to calculate the local imaging sharpness AS.

In addition to first and second derivatives, the imaging sharpness detection unit 4 can also use focus metrics FM which are based upon statistical reference variables, e.g. on a distribution of the gray scale values within the camera image KB. Furthermore, it is possible to use focus metrics FM that are histogram-based, e.g. a range histogram or an entropy histogram. In addition, the local imaging sharpness AS can also be calculated by means of the imaging sharpness detection unit 4 with the aid of correlation methods, in particular autocorrelation. In a further possible embodiment, the imaging sharpness detection unit 4 can also perform data compression methods in order to calculate the local imaging sharpness AS. Different focus metrics FM can also be combined to calculate the local imaging sharpness AS by means of the imaging sharpness detection unit 4.

In one possible embodiment of the camera assistance system 1 in accordance with the invention, the user also has the option of selecting the focus metric FM to be used from a group of predefined focus metrics FM depending upon the application. In one possible embodiment, the selected focus metric FM can be displayed to the user on the display unit 3 of the camera assistance system 1. Different focus metrics FM are suitable for different applications. In a further embodiment, it is also possible to individually define the focus metric to be used via an editor by means of the user interface of the camera assistance system 1 for the desired application, in particular for test purposes.

FIG. 2 shows a block diagram to illustrate another possible embodiment of a camera assistance system 1 in accordance with the invention. Corresponding units are designated by corresponding reference numerals.

In the exemplified embodiment illustrated in FIG. 2, the camera assistance system 1 has a depth measuring unit 8. The camera assistance system 1 has a depth measuring unit 8 which provides a depth map TK which is processed by the image processing unit 2 of the camera assistance system 1 in order to generate the virtual three-dimensional projection surface PF. The depth measuring unit 8 is suitable for measuring an instantaneous distance of recording objects, in particular the recording subject AM illustrated in FIG. 2, from the camera 5. For this purpose, the depth measuring unit 8 can generate a corresponding depth map TK by measuring a running time or by measuring a phase shift of sonic waves or of electromagnetic waves. The depth measuring unit 8 can have one or more sensors 9, as also illustrated in the exemplified embodiment according to FIG. 3. In one possible embodiment, the depth measuring unit 8 has at least one sensor 9 for detecting electromagnetic waves, in particular light waves. Furthermore, the depth measuring unit 8 can have a sensor 9 for detecting sonic waves, in particular ultrasonic waves. In one possible embodiment, the sensor data SD generated by the sensors 9 of the depth measuring unit 8 are fused by a processor 10 of the depth measuring unit 8 in order to generate the depth map TK, as also described in greater detail in conjunction with FIG. 3.

In one possible embodiment, the depth measuring unit 8 has at least one optical camera sensor for generating one or more depth images which are processed by the processor 10 or the depth measuring unit 8 in order to generate the depth map TK. The depth measuring unit 8 outputs the generated depth map TK to the image processing unit 2 of the camera assistance system 1, as illustrated schematically in FIG. 2. In one possible embodiment, the depth measuring unit 8 has a stereo image camera which has optical camera sensors 9 for generating stereo camera image pairs which are processed by the processor 10 of the depth measuring unit 8 in order to generate the depth map TK. In one possible embodiment, the image processing unit 2 has a depth map filter for multidimensional filtering of the depth map TK provided by the depth measuring unit 8. In an alternative implementation, the depth map filter is located at the output of the depth measuring unit 8.

In the exemplified embodiment of the camera assistance system 1 illustrated in FIG. 2, the camera image KB obtained from the camera 5 is projected onto a virtual three-dimensional projection surface PF by means of the image processing unit 2, the topology of which is created from the depth map TK ascertained by means of the depth measuring unit 8. Since the resolution of the depth map TK generated by the depth measuring unit 8 can be lower than the image resolution of the camera 5 itself, in one possible embodiment multi-dimensional filtering, in particular smoothing, of the depth map TK is effected, wherein parameters P, such as strength and radius, can be set.

In one possible embodiment, the image processing unit 2 performs a calibration on the basis of the depth map TK provided by the depth measuring unit 8 and on the basis of the camera image KB obtained from the camera 5, said calibration taking into account the spatial relative position of the depth measuring unit 8 to the camera 5. In this embodiment, the measurement accuracy as well as the position of the sensors 9 of the depth measuring unit 8 relative to the camera 5 as well as the accuracy of the sharpness setting (scale, drive) of the camera lens 5A can be decisive. Therefore, in one possible embodiment it is advantageous to carry out a calibration function by means of additional contrast measurement. This calibration can typically be performed at a plurality of measuring distances in order to optimize the local contrast values. The calibration curve is then created on the basis of these measurement values or supporting points.

In a further possible embodiment of the camera assistance system 1 in accordance with the invention, the image processing unit 2 can ascertain a movement vector and a probable future position of the recording subject AM within a camera image KB, which is received from the camera 5, on the basis of depth maps TK provided by the depth measuring unit 8 over time, and can derive therefrom a change in the local imaging sharpness AS of the received camera image KB. By means of this pre-calculation, it is possible to compensate for delays which are caused by the measurement and processing of the camera image KB.

FIG. 3 shows one possible implementation of the depth measuring unit 8 of the embodiment of the camera assistance system 1 in accordance with the invention, as illustrated in FIG. 2. The depth measuring unit 8 has at least one sensor 9. In one possible embodiment, this sensor 9 can be a sensor for detecting electromagnetic waves, in particular light waves. Furthermore, the sensor 9 can be a sensor for detecting sonic waves or acoustic waves, in particular ultrasonic waves. In the exemplified embodiment of the depth measuring unit 8 illustrated in FIG. 3, the depth measuring unit 8 has a number of N sensors 9-1 to 9-N. The sensor data SD generated by each of the sensors 9 are supplied to a processor 10 of the depth measuring unit 8. The processor 10 generates a depth map TK from the supplied sensor data SD from the various sensors 9. For this purpose, the processor 10 can perform sensor data fusion. In general, the linking of output data from a plurality of sensors 9 is defined as sensor data fusion. With the aid of sensor data fusion, a high-quality depth map TK can be created. The sensors 9 can be located in separate units.

The various sensors 9 of the depth measuring unit 8 can be based upon different measuring principles. For example, one group of sensors 9 can be provided in order to detect electromagnetic waves, whereas another group of sensors 9 is provided in order to detect sonic waves, in particular ultrasonic waves. The sensor data SD generated by the various sensors 9 of the depth measuring unit 8 are fused by the processor 10 of the depth measuring unit 8 in order to generate the depth map TK. For example, the depth measuring unit 8 can include camera sensors, radar sensors, ultrasonic sensors, or lidar sensors as sensors 9. The radar sensors, the ultrasonic sensors and the lidar sensors are based upon the measurement principle of running time measurement. During running time measurement, distances and velocities are measured indirectly based upon the time it takes a measurement signal to strike an object and then be reflected back.

In the case of the camera sensors, running time measurement is not performed but instead camera images KB are generated as a visual representation of the environment. In addition to color information, texture and contrast information can also be obtained. Since the measurements with the camera 5 are based upon a passive measurement principle, objects are detected only if they are illuminated by light. The quality of the camera images KB generated by camera sensors can be limited, where appropriate, by environmental conditions such as snow, ice or fog, or in prevailing darkness. In addition, the camera images KB do not provide any distance information. Therefore, in one possible embodiment the depth measuring unit 8 preferably has at least one radar sensor, one ultrasonic sensor or one lidar sensor.

In order to obtain 3D camera images KB, at least two camera sensors can also be provided in one possible embodiment of the depth measuring unit 8. In one possible embodiment, the depth measuring unit 8 has a stereo image camera which includes optical camera sensors for generating stereo camera image pairs. These stereo camera image pairs are processed by the processor 10 of the depth measuring unit 8 in order to generate the depth map TK. By using different sensors 9, the reliability of the depth measuring unit 8 can be increased under different environmental conditions. Furthermore, by using different sensors 9 and subsequent sensor data fusion, the measuring accuracy and the quality of the depth map TK can be increased.

The visual ranges of sensors 9 are usually restricted. By using a plurality of sensors 9 within the depth measuring unit 8, the visual range of the depth measuring unit 8 can be increased. Furthermore, the resolution of ambiguities can be simplified by using a plurality of sensors 9. Additional sensors 9 provide additional information and thus expand the knowledge of the depth measuring unit 8 with regard to the environment. By using different sensors 9 it is also possible to increase the measuring rate or the rate at which the depth map TK is generated.

FIG. 4 shows a simple flow diagram illustrating the mode of operation of the inventive method for assisting in the focusing of a camera 5. In the exemplified embodiment illustrated in FIG. 4, the method includes substantially three main steps.

In a first step S1, a camera image KB of a recording subject AM within a field of view BF of a camera is received by means of an image processing unit.

In a further step S2, the received camera image KB is projected onto a virtual three-dimensional projection surface PF by means of the image processing unit. In this case, the height values of the virtual three-dimensional projection surface PF correspond to a local imaging sharpness AS of the received camera image KB.

In a further step S3, the camera image KB projected onto the virtual three-dimensional projection surface PF is displayed on a display unit. This display unit can be e.g. the display units 3 of the camera assistance system 1 illustrated in FIGS. 1, 2.

In one possible embodiment, the imaging sharpness AS of the received camera image KB is calculated in dependence upon a predefined focus metric FM in step S2. The local imaging sharpness AS can be calculated using a contrast value-based predefined focus metric FM on the basis of ascertained contrast values of the unprocessed camera image KB received from the camera 5 and/or on the basis of ascertained local contrast values of the processed useful camera image NKB generated therefrom by the image processing unit 2 and can then be multiplied by a settable scaling factor SF in order to calculate the height values of the virtual three-dimensional projection surface PF. Alternatively, the virtual three-dimensional projection surface PF can be generated on the basis of a depth map TK which is provided by means of a depth measuring unit 8. This requires the camera assistance system 1 to have a corresponding depth measuring unit 8.

FIG. 5 shows a further flow diagram illustrating an embodiment variant of the method for assisting in the focusing of a camera 5, as illustrated in FIG. 4.

After a start step S0, a camera image KB of a recording subject AM is transmitted to an image processing unit 2 in step S1. The camera image KB is a two-dimensional camera image KB which includes a matrix of pixels.

In a further step S2, the received camera image KB is projected by means of the image processing unit 2 of the camera assistance system 1 onto a virtual three-dimensional projection surface PF, of which the height values correspond to a local imaging sharpness AS of the received two-dimensional camera image KB. This second step S″ can include a plurality of partial steps, as illustrated in the flow diagram according to FIG. 5.

In a partial step S2A, the local imaging sharpness AS of the received camera image KB can be calculated in dependence upon a specified focus metric FM. This focus metric FM can be e.g. a contrast value-based focus metric FM. In one possible implementation, the local imaging sharpness AS can be calculated in the partial step S2A using a contrast value-based focus metric FM on the basis of ascertained local contrast values of the unprocessed camera image KB received from the camera 5 and/or on the basis of ascertained local contrast values of the processed useful camera image NKB generated therefrom by the image processing unit 2. In one possible implementation, this local imaging sharpness AS can additionally be multiplied by a settable scaling factor SF in order to calculate the height values of the virtual three-dimensional projection surface PF. In a further partial step S2B, the virtual three-dimensional projection surface PF is generated on the basis of the height values. In a further partial step S2C, the two-dimensional camera image KB is projected onto the virtual three-dimensional projection surface PF generated in the partial step S2B. The camera image KB is projected onto the virtual three-dimensional projection surface PF, of which the height values correspond to the local contrast values in one possible implementation. The camera image KB is mapped or projected onto the generated virtual three-dimensional projection surface PF.

In the exemplified embodiment illustrated in FIG. 5, the display device or display unit 3 used has a 3D display capability, e.g. a stereo display with corresponding 3D glasses (polarizing filter, shutter or anaglyph) or an autostereoscopic display. In order to display the camera image KB of the camera 5 projected onto the virtual three-dimensional projection surface PF, a stereo image pair which comprises a camera image KB-L for the left eye and a camera image KB-R for the right eye of the viewer is initially calculated in a partial step S3A. In a further partial step S3B, the calculated stereo image pair is displayed on the 3D display device 3, specifically the left camera image KB-L for the left eye and the right camera image KB-R for the right eye. In the exemplified embodiment illustrated in FIG. 5, the stereo image pair is displayed on a 3D display unit 3 of the camera assistance system 1. If the camera assistance system 1 has a 3D display unit 3, the camera image KB projected onto the virtual three-dimensional projection surface PF can be directly displayed in three dimensions in order to generate a stereo image pair.

If the camera assistance system 1 does not have a 3D display unit 3, in one possible embodiment the image processing unit 2 calculates a pseudo 3D illustration with artificially generated shadows or an oblique view on the basis of the camera image KB projected onto the virtual three-dimensional projection surface PF, said pseudo 3D illustration or oblique view being displayed on the available 2D display unit 3 of the camera assistance system 1.

In order to prevent the illustration from being too fragmented, in one possible embodiment provision is made to carry out filtering which forms the illustrated surface more harmoniously. In this case, the displayed image can acquire in the region of the depth of field ST a 3D structure resembling an oil painting. Furthermore, in one possible embodiment a threshold value can be provided, above which 3D mapping is performed. As a consequence, the virtual projection surface PF is planar below a certain contrast value.

In a further possible embodiment, the intensity of the 3D illustration can be set on the 3D display unit 3. The intensity of the 3D illustration, i.e. how much places with high contrast values approach the viewer, can be set with the aid of a scaling factor SF. Therefore, the image content of the projected camera image KB always remains clearly recognizable for the user and is not obscured by superimposed pixel clouds or other illustrations.

In order to optimize contrast detection, the camera assistance system 1 can also consider a camera image KB with high dynamic range in addition to the processed camera image KB in order to reduce quantization and limiting effects which occur specifically in very dark or bright regions and lead to the reduction in quality in completely processed camera images KB.

Furthermore, it is possible for an image with a high contrast range to be provided by the camera 5 in addition to the processed useful camera image NKB. In a further embodiment, the system generates, from the image with high dynamic range, the useful camera image NKB which is converted into the corresponding color space and the desired dynamic range. The information required for this purpose, in particular LUT and color space, can either be obtained from the camera 5 via data communication by means of the image processing unit 2 or can be set on the device itself.

FIG. 6 schematically shows the depth of field ST in a camera 5. The camera lens 5A of the camera 5 has a diaphragm, behind which a recording sensor plane of the recording sensor 5B is located, as illustrated in FIG. 6. A blur circle UK can be defined in the recording sensor plane of the recording sensor 5B. In a real imaging system, in which both the viewer's or user's eye and the recording sensor 5B have a limited resolving power as a result of its discrete pixels, the blur circle UK represents the deviation from a sharp, i.e. punctiform, image which is tolerable. If an acceptable diameter of the blur circle U is indicated, the object region which is imaged sharply is located between the boundaries SEᵥ and SEₕ of the depth of field region ST, as illustrated in FIG. 6. FIG. 6 shows the object distance a between the plane of focus SE and the lens of the camera lens 5A. Furthermore, FIG. 6B shows the image distance b between the lens and the recording sensor plane of the recording sensor 5B.

The camera lens 5A of the camera 5 cannot accommodate different object distances like the eye of the viewer. Therefore, for different distances, the distance between the camera lens 5A or the lens thereof and the recording sensor plane must be varied. The luminous flux which falls upon the recording sensor 5B can be regulated with the aid of the diaphragm of the camera lens 5A. The measure of the amount of light occurring is the relative opening

$$\frac{{D}_{Blende}}{{F}^{′}} ,$$

wherein D_{BLENDE} is the diaphragm diameter of the camera lens 5A and F is the focal length (focal length BW) of the camera lens 5A. The f-number k of the camera 5 is determined by the ratio of the focal length [symbol] and the diaphragm diameter D BLENDE of the diaphragm of the camera lens 5A:

k= [symbol] /D_{BLENDE}

In general, the following applies for the front limit aᵥ and rear limit aₕ of the depth of field ST:

$${a}_{v} = \frac{{aF}^{′2}}{{F}^{′2} - {U}^{′} k ( a + {F}^{′} )}$$

$$and$$

$${a}_{h} = \frac{{aF}^{′2}}{{F}^{′2} + {U}^{′} k \cdot ( a + {F}^{′} )}$$

where [symbol] is the diameter of the blur circle UK,
where [symbol] is the set focal length BW,
where k is the set f-number, and
where a is the object distance.

The depth of field ST is then ST=Δa=aᵥ−aₕ.

In one possible embodiment, the limits of the depth of field ST can be determined in real time by means of a processor or FPGA of the image processing unit 2 using the equations stated above. Alternatively, the two limits of the depth of field ST are determined with the aid of stored readout tables (Look Up Table).

In one possible embodiment of the camera assistance system 1 in accordance with the invention, the image processing unit 2 receives via an interface the focus position FL, which is set by means of the setting unit 6 of the camera assistance system 1, as a parameter P and superimposes the focus position FL as a semitransparent plane of focus SE on the camera image KB, which is projected onto the virtual three-dimensional projection surface PF, for display on the display unit 3 of the camera assistance system 1, as illustrated in FIGS. 7A, 7B. FIG. 7A shows a front view of the display surface of a display unit 3, wherein a head of a statue is shown as an example of a recording subject AM. However, in most applications, in particular in moving image cameras or motion picture cameras, the recording subject AM is dynamically moving and is not arranged statically. In a preferred embodiment, a viewpoint on the camera image KB which is projected onto the virtual three-dimensional projection surface and is displayed on the display unit 3 of the camera assistance system 1 can be set. FIG. 7B shows a view of the recording subject AM from the front with the viewpoint located obliquely above. It is also clearly apparent how the semitransparent plane of focus SE intersects the surface of the recording subject AM. The viewpoint on the 3D scene and the plane of focus SE can be selected such that the viewer or user can take a view obliquely from the front, as illustrated in FIG. 7B, in order to better assess the shift of the plane of focus SE in depth or in the z-direction. In order to prevent the dedicatedly illustrated camera image KB from becoming too blurred in the case of large depth differences, threshold values can be defined, above which the projected camera image KB of the recording subject AM is displayed in each case on a maximum rear plane and/or front plane.

Instead of visualizing only the plane of focus SE, it is also possible to visualize the depth of field range of the depth of field ST by two additional planes for the rear limit and for the front limit of the depth of field ST, as illustrated in FIGS. 8A, 8B. FIG. 8A shows a front view of a display surface of a display unit 3 of the camera assistance system 1. FIG. 8B in turn shows a display from obliquely in front on the recording subject AM by corresponding perspective rotation. FIG. 8B clearly shows two slightly spaced-apart oblique planes SEᵥ, SEₕ for the front limit aᵥ and rear limit aₕ of the depth of field ST. Located between the front plane of focus SEᵥ and the rear plane of focus SEₕ which define the limits of the depth of field ST is the actual plane of focus SE, as illustrated schematically in FIG. 6. The image processing unit 2 can superimpose a first semitransparent plane SEᵥ for illustrating the front limit of the depth of field ST and a second semitransparent plane SEₕ for illustrating the rear limit of the depth of field ST on the camera image KB which illustrates the recording subject AM and is projected onto the virtual three-dimensional projection surface PF, for display on the display unit 3 of the camera assistance system 1, as illustrated in FIGS. 8A, 8B. In one possible embodiment, the semi-transparent plane of focus SE and the two planes of focus SEᵥ, SEₕ for illustrating the front limit of the depth of field ST and for illustrating the rear limit of the depth of field ST can intersect a focus scale which is displayed to the user on an edge of the display surface of the display unit 3 of the camera assistance 1.

The focus distance or focus position FL is preferably transmitted from the camera system to the image processing unit 2 via a data interface and subsequently superimposed as a semitransparent plane SE on the illustrated 3D image of the recording subject AM, as illustrated in FIGS. 7A, 7B. After changing the focus setting or focus position FL, this plane of focus SE can be shifted in depth or in the z-direction. On the basis of the visible overlaps of the semitransparent plane of focus SE with the recording subject AM illustrated in the displayed camera image KB, a user can intuitively and quickly perform a precise focus setting of the camera 5. In one possible embodiment, image regions of the illustrated camera image KB which are located in front of the plane of focus SE are illustrated clearly, whereas elements behind the illustrated plane of focus SE are illustrated filtered by the semitransparent plane SE.

In order not to disrupt an image impression too much, the illustrated semitransparent plane of focus SE can also be illustrated only locally in certain depth regions of the virtual projection surface PF. For example, the semitransparent plane SE can be illustrated only in regions, of which the distances are within a certain range behind the current plane of focus SE (i.e. current distance to current distance+/−x %). It is also possible to set a minimum width of the illustrated depth of field range ST.

If the display unit 3 has a touch-sensitive touch-screen, the user can also perform inputs with finger gestures. Therefore, in this embodiment the setting unit 6 is integrated in the display unit 3.

By reading the focus scale located at the edge of the display surface of the display unit 3, the user can also read quantitative information regarding the position of the plane of focus SE or the limit planes of focus of the depth of field ST. In a further possible embodiment, this value can also be stored together with the generated useful camera image NKB in the image memory 7 of the camera assistance system 1. This facilitates further data processing of the intermediately stored useful camera image NKB. In one possible embodiment, the image processing unit 2 can automatically ascertain or calculate the instantaneous depth of field ST on the basis of an instantaneous iris diaphragm opening BÖ of the diaphragm as well as on the basis of the instantaneously set focus position FL and, where appropriate, on the basis of the instantaneously set focal length of the camera lens 5A. This can be effected e.g. using associated stored depth of field tables for the camera lens type of the camera lens 5A in use at that time.

In one possible embodiment of the camera assistance system 1 in accordance with the invention, it is possible to switch between different display options. For example, the use has the option of switching between a display according to FIGS. 7A, 7B and a display according to FIGS. 8A, 8B In the first display mode, the plane of focus SE is thus displayed from the view of a settable viewpoint or viewing angle. In a second display mode, the front limit and the back limit of the depth of field ST are displayed, as illustrated in FIGS. 8A, 8B. Furthermore, in one possible embodiment variant the color and/or texture as well as the density of the sharpness indication can be selected by the user with the aid of the user interface.

In a further possible embodiment, it is also possible to switch between manual focusing and autofocusing in the camera assistance system 1. The inventive method for assisting in the focusing, as illustrated e.g. in FIG. 4, is carried out when manual focusing of the camera 5 is selected.

The exemplified embodiments illustrated in the different embodiment variants according to FIGS. 1 to 8 can be combined with one another. For example, the camera assistance system 1 illustrated in FIG. 1 with an imaging sharpness detection unit 4 can be combined with the camera assistance system 1 illustrated in FIG. 2 which has a depth measuring unit 8. In this embodiment, the virtual projection surface PF is generated by means of the image processing unit 2 taking into account the depth map TK generated by the depth measuring unit 8 and taking into account the imaging sharpness AS calculated by the imaging sharpness detection unit 4. This can additionally increase the precision or quality of the generated virtual projection surface PF. If the system 1 has both an imaging sharpness detection unit 4 and a depth measuring unit 8, in a further embodiment variant the user input can also be switched between a calculation of the virtual projection surface PF on the basis of the imaging sharpness AS or on the basis of the depth map TK, depending upon the application.

Further embodiments are possible. For example, the camera image KB generated by the recording sensor 5B can be temporarily stored in a dedicated buffer, to which the image processing unit 2 has access. In addition, a plurality of sequentially produced camera images KB can also be intermediately stored in such a buffer. The image processing unit 2 can also automatically ascertain a movement vector and a probable future position of the recording subject AM within an image, which is received from the camera 5, on the basis of a plurality of depth maps TK provided over time, and can derive therefrom a change in the local imaging sharpness AS of the received camera image KB. This pre-calculation or prediction makes it possible to compensate for any delays which are caused by the measuring and processing of the camera image KB. In a further possible implementation, a sequence of depth maps TK can also be stored in a buffer of the camera assistance system 1. In a further possible implementation variant, the image processing unit 2 can also ascertain the virtual three-dimensional projection surface PF on the basis of a plurality of depth maps TK of the depth measuring unit 8 which are formed in sequence. Furthermore, a pre-calculation or prediction of the virtual three-dimensional projection surface PF can also be performed on the basis of a detected sequence of depth maps TK output by the depth measuring unit 8.

In a further possible embodiment, depending on the application and user input, the depth map TK can be calculated by means of the depth measuring unit 8 on the basis of sensor data SD generated by accordingly selected sensors 9.

The units illustrated in the block diagrams according to FIGS. 1, 2 can be implemented at least in part by means of programmable software modules. In one possible embodiment, a processor of the image processing unit 2 executes a recognition algorithm for recognizing significant object parts of the recording subject AM contained in the received camera image KB and, if required, can request corresponding image sections within the camera image KB with increased resolution from the camera 5 via an interface. This can reduce the data volume of the image transmissions. Furthermore, in cases where the sensor resolution of the recording sensor 5B is lower than the resolution of the monitor of the display unit 3, the system 1 can detect image sections, in which significant object parts are contained, via the recognition algorithm and request these image sections from the camera 5 in addition to the overall camera image KB (which is usually present in reduced resolution). This is effected preferably via a bidirectional interface. This bidirectional interface can also be formed by means of a standardized network interface. In one possible embodiment, compression data formats are used in order to transmit the overall image and partial image or image section.

The camera assistance system 1 in accordance with the invention is particularly suitable for use with moving image cameras or motion picture cameras which are suitable for generating camera image sequences of a moving recording subject AM. In order to focus the camera lens 5A of the camera 5, its surface cannot be located exactly in an object plane corresponding to the instantaneous focus distance of the camera lens 5A, since the content within a certain distance range, which covers the object plane and the regions in front of and behind it, is also sharply imaged by the camera lens 5A onto the recording sensor 5B of the moving image camera 5. The configuration of this distance range—referred to as the focus range or even depth of field ST—along the optical axis depends in particular also upon the instantaneously set f-number of the camera lens 5A.

The narrower the focus range or depth of field ST, the more precise or selective the focusing, i.e. the focus distance of the camera lens 5A can be adapted to the distance of one or more objects of the respective scenery to be imaged sharply in order to ensure that the objects or recording subjects AM are in the focus range of the camera lens 5A when being recorded. If the objects to be imaged sharply change their distance from the camera lens 5A of the moving image camera 5 during recording by the moving image camera 5, the camera assistance system 1 in accordance with the invention can be used to precisely track the focus distance. Similarly, the focus distance can be changed such that initially one or more objects are imaged sharply at a first distance, but then one or more objects are imaged sharply at a different distance. The camera assistance system 1 in accordance with the invention allows a user to continuously control the focus setting in order to adapt it to the changed distance of the recording subject AM moving in front of the camera lens 5A. As a result, the function of focusing the camera lens 5A, which is also referred to as pulling focus, can be effectively assisted with the aid of the camera system 1 in accordance with the invention. The manual focusing or pulling focus can be performed e.g. by the cameraman himself or by a camera assistant or a so-called focus-puller who is specifically responsible for this.

For precise focusing, in one possible embodiment the option for instantaneous continuous setting of the focus position FL can be provided. For example, focusing can be effected using a scale which is printed on or adjacent to a rotary knob which can be actuated in order to adjust the focus distance. In the camera assistance system 1 in accordance with the invention, the option of illustrating a focus setting with the aid of the plane of focus SE, as illustrated in FIGS. 7A, 7B, as well as the option of illustrating a depth of field ST according to FIGS. 8A, 8B, make it considerably easier for the user to make the most suitable focus setting and to continuously track it accordingly during the recording. Focusing or pulling focus is thus made considerably easier and can be performed intuitively by the respective user. Furthermore, the user has the option of setting the illustration of the plane of focus SE and the depth of field ST according to his preferences or habits, e.g. by changing the viewpoint on the plane of focus SE or by adjusting the scaling factor SF.

In a preferred embodiment, the configuration of the illustration selected by the user is stored in a user-specific manner such that the user can directly reuse the illustration parameters preferred for him the next time he makes a recording with the aid of the moving image camera 5. Here, the user optionally additionally has the option of configuring further information to be illustrated on the display surface of the display unit 3 together with the plane of focus SE or the depth of field ST. For example, the user can pre-configure which further recording parameters P are to be displayed for him on the display surface of the display unit 3. Furthermore, the user can configure whether the focus scale located at the edge should be shown or hidden. Furthermore, in one possible embodiment variant, the user has the option of switching between different units of measurement, in particular SI units (e.g. meters) or other widely used units of measurement (e.g. inches). For example, the depth of field ST illustrated in FIG. 8B can be displayed in millimeters, centimeters on a scale, provided that the user pre-configures this accordingly for himself. In one possible implementation, the user can identify himself to the camera assistance system 1 such that the configuration of the illustration desired for him is automatically loaded and executed. The user also has the option of setting optical illustration of the semitransparent planes SE, e.g. with respect to the color of the semitransparent plane SE. The display surface of the display unit 3 can be an LCD, TFT or OLED display surface. This display surface comprises a two-dimensional matrix of image points in order to reproduce image information. In one possible embodiment, the user has the option of setting the resolution of the display surface of the display unit 3.

In one possible embodiment of the camera assistance system 1 in accordance with the invention, the instantaneous depth of field ST is ascertained by means of the image processing unit 2 on the basis of the set iris diaphragm opening BÖ of the diaphragm, the set focus position FL and, where appropriate, the set focal length of the camera lens 5A with the aid of a depth of field table. In this case, an associated depth of field table can be stored in a memory for different camera lens types in each case, to which the image processing unit 2 has access for calculating the instantaneous depth of field ST. In one possible embodiment variant, the camera lens 5A communicates the camera lens type to the image processing unit 2 via an interface. On the basis of the obtained camera lens type, the image processing unit 2 can read out a corresponding depth of field table from the memory and use it to calculate the depth of field ST. In one possible embodiment, the depth of field tables for different camera lens types are stored in a local data memory of the camera assistance system 1. In an alternative embodiment, the depth of field table is stored in a memory of the camera 5 and is transmitted to the image processing unit 2 via the interface.

In a further possible embodiment, the user has the option of selecting a display of the used depth of field table on the display surface of the display unit 3. For example, after a corresponding input on the display surface of the display unit 3, the type of camera lens 5A currently in use and optionally also the associated depth of field table are displayed to the user. This gives the user better control which corresponds to the intended application.

In one possible embodiment, the camera assistance system 1 illustrated in FIGS. 1, 2 forms a separate device which can be connected to the remaining units of the camera system 1 via interfaces. Alternatively, the camera assistance system 1 can also be integrated into a camera or a camera system. In one possible embodiment, the camera assistance system 1 can also be modular in structure. In this embodiment, the possible modules of the camera assistance system 1 can consist e.g. of a module for the depth measuring unit 8, a module for the image processing unit 2 of the camera assistance system 1, a display module 3 for the display unit 3 and a module for the imaging sharpness detection unit 4. The different functions can also be combined in another way to form modules. The different modules can be provided for different implementation variants. For example, the user has the option of building his preferred camera assistance system 1 by assembling the suitable modules in each case. In one possible implementation, the different modules can be electromechanically connected to one another via corresponding interfaces and are interchangeable if required. Further embodiment variants are possible. In one possible embodiment, the camera assistance system 1 has a dedicated power supply module which is operable independently of the rest of the camera system 1 or the camera 5.

### LIST OF REFERENCE SIGNS

1 camera assistance system
2 image processing unit
3 display unit
4 imaging sharpness detection unit
5 camera
5A camera lens
5B recording sensor
6 setting unit
7 image memory
8 depth measuring unit
9 sensor
10 processor of the depth measuring unit
AM recording subject
BF field of view
BÖ diaphragm opening
BW focal length
FL focus position
FM focus metric
KB camera image
NKB useful camera image
P recording parameter
SD sensor data
SE plane of focus
SF scaling factor
ST depth of field
TK depth map
UK blur circle

1. A camera assistance system comprising:
an image processing unit which processes a camera image of a recording subject received from a camera to generate a useful camera image, wherein the camera image received from the camera is projected onto a virtual three-dimensional projection surface, of which the height values correspond to a local imaging sharpness of the received camera image; and comprising
a display unit which displays the camera image projected by the image processing unit onto the virtual three-dimensional projection surface.

2. The camera assistance system as claimed in claim 1, wherein the local imaging sharpness of the received camera image is determined by means of an imaging sharpness detection unit of the camera assistance system.

3. The camera assistance system as claimed in claim 2, wherein the imaging sharpness detection unit has a contrast detection unit or a phase detection unit.

4. The camera assistance system as claimed in claim 2, wherein the imaging sharpness detection unit of the camera assistance system calculates the local imaging sharpness of the received camera image in dependence upon at least one focus metric.

5. The camera assistance system as claimed in claim 4, wherein the imaging sharpness detection unit calculates the imaging sharpness of the received camera image using a contrast value-based focus metric on the basis of ascertained local contrast values of the unprocessed camera image received from the camera and/or on the basis of ascertained local contrast values of the processed useful camera image generated therefrom by the image processing unit.

6. The camera assistance system as claimed in claim 5, wherein the image sharpness detection unit ascertains the local contrast values of the two-dimensional camera image received from the camera and/or of the two-dimensional useful camera image generated therefrom, in each case for individual pixels of the camera image or in each case for a group of pixels of the camera image.

7. The camera assistance system as claimed in claim 1, wherein the camera image received from the camera is filtered by a spatial frequency filter in order to reduce fragmentation of the camera image which is displayed on the display unit and projected onto the virtual projection surface.

8. The camera assistance system as claimed in claim 1, wherein the image processing unit calculates a stereo image pair on the basis of the camera image projected onto the virtual three-dimensional projection surface, said stereo image pair being displayed on a 3D display unit of the camera assistance system.

9. The camera assistance system as claimed in claim 1, wherein the image processing unit calculates a pseudo-3D illustration with artificially generated shadows or an oblique view on the basis of the camera image projected onto the virtual three-dimensional projection surface, which illustration is displayed on a 2D display unit of the camera assistance system.

10. The camera assistance system as claimed in claim 1, wherein the local imaging sharpness is calculated using a contrast value-based focus metric on the basis of ascertained local contrast values of the unprocessed camera image received from the camera and/or on the basis of ascertained local contrast values of the processed useful camera image generated therefrom by an image processing unit and is multiplied by a settable scaling factor in order to calculate the height values of the virtual three-dimensional projection surface.

11. The camera assistance system as claimed in claim 1, wherein the useful camera image generated by the image processing unit is stored in an image memory.

12. The camera assistance system as claimed in claim 1, wherein the image processing unit executes a recognition algorithm for recognizing significant object parts of the recording subject contained in the received camera image and requests corresponding image sections within the camera image with increased resolution from the camera via an interface.

13. The camera assistance system as claimed in claim 1, wherein the camera assistance system has a depth measuring unit which provides a depth map which is processed by the image processing unit in order to generate the virtual three-dimensional projection surface.

14. The camera assistance system as claimed in claim 13, wherein the depth measuring unit is suitable for measuring an instantaneous distance of recording objects from the camera by measuring a running time or by measuring a phase shift of ultrasonic waves or of electromagnetic waves, and for generating a corresponding depth map.

15. The camera assistance system as claimed in claim 14, wherein the depth measuring unit has at least one sensor for detecting electromagnetic waves and/or a sensor for detecting sonic waves, in particular ultrasonic waves.

16. The camera assistance system as claimed in claim 15, wherein the sensor data (SD) generated by the sensors of the depth measuring unit are fused by a processor of the depth measuring unit in order to generate the depth map.

17. The camera assistance system as claimed in claim 13, wherein the depth measuring unit has at least one optical camera sensor for generating one or more depth images which are processed by a processor of the depth measuring unit in order to generate the depth map.

18. The camera assistance system as claimed in claim 17, wherein a stereo image camera is provided which has optical camera sensors for generating stereo camera image pairs which are processed by the processor of the depth measuring unit in order to generate the depth map.

19. The camera assistance system as claimed in claim 13, wherein the image processing unit has a depth map filter for multidimensional filtering of the depth map provided by the depth measuring unit.

20. The camera assistance system as claimed in claim 1, wherein a setting unit is provided for setting recording parameters of the camera.

21. The camera assistance system as claimed in claim 20, wherein the recording parameters EP which can be set by means of the setting unit of the camera assistance system comprise a focus position, an iris diaphragm opening, and a focal length of a camera lens of the camera, as well as an image recording frequency and a shutter speed.

22. The camera assistance system as claimed in claim 1, wherein the image processing unit receives via an interface the focus position set by means of the setting unit of the camera assistance system and superimposes this as a semitransparent plane of focus on the camera image, which is projected onto the virtual three-dimensional projection surface, for display on the display unit of the camera assistance system.

23. The camera assistance system as claimed in claim 1, wherein a viewpoint on the camera image which is projected onto the virtual three-dimensional projection surface and is displayed on the display unit of the camera assistance system can be set.

24. The camera assistance system as claimed in claim 22, wherein the semitransparent plane of focus intersects a focus scale displayed on an edge of the display unit of the camera assistance system.

25. The camera assistance system as claimed in claim 21, wherein the image processing unit ascertains an instantaneous depth of field on the basis of a set iris diaphragm opening, a set focus position and/or a set focal length of the currently used camera lens of the camera.

26. The camera assistance system as claimed in claim 21, wherein the image processing unit superimposes a semitransparent plane for illustrating a front limit of a depth of field and a further semitransparent plane for illustrating a rear limit of the depth of field on the camera image projected onto the virtual three-dimensional projection surface, for display on the display unit of the camera assistance system.

27. The camera assistance system as claimed in claim 21, wherein the image processing unit receives a type of camera lens of the camera communicated via an interface and ascertains the instantaneous depth of field from an associated stored depth of field table of the camera lens type on the basis of the set iris diaphragm opening and the set focus position and/or the set focal length of the currently used camera lens.

28. The camera assistance system as claimed in claim 13, wherein the image processing unit performs a calibration on the basis of the depth map provided by the depth measuring unit and on the basis of the camera image obtained from the camera, said calibration taking into account the relative position of the depth measuring unit to the camera.

29. The camera assistance system as claimed in claim 13, wherein the image processing unit ascertains a movement vector and a probable future position of the recording subject within a camera image, which is received from the camera, on the basis of depth maps provided by the depth measuring unit over time, and derives therefrom a change in the local imaging sharpness of the received camera image.

30. A camera comprising a camera assistance system as claimed in claim 1 for assisting in the focusing of the camera.

31. The camera as claimed in claim 30, wherein the camera is a moving image camera.

32. A method for assisting in the focusing of a camera comprising the steps of:
receiving a camera image of a recording subject by an image processing unit from the camera;
projecting the received camera image by the image processing unit onto a virtual three-dimensional projection surface, of which the height values correspond to a local imaging sharpness of the received camera image; and
displaying the camera image, which is projected on the virtual three-dimensional projection surface, on a display unit.

33. The method as claimed in claim 32, wherein the imaging sharpness of the received camera image is calculated in dependence upon a focus metric.

34. The method as claimed in claim 33, wherein the local imaging sharpness is calculated using a contrast value-based focus metric on the basis of ascertained local contrast values of the unprocessed camera image received from the camera and/or on the basis of ascertained local contrast values of the processed useful camera image generated therefrom by an image processing unit and is multiplied by a settable scaling factor in order to calculate the height values of the virtual three-dimensional projection surface.

35. The method as claimed in claim 31, wherein the virtual three-dimensional projection surface is generated on the basis of a depth map which is provided by means of a depth measuring unit.

36. The camera assistance system as claimed in claim 14, wherein the depth measuring unit is suitable for measuring an instantaneous distance of the recording subject from the camera by measuring a running time or by measuring a phase shift of ultrasonic waves or electromagnetic waves, and for generating a corresponding depth map.

37. The camera assistance system as claimed in claim 15, wherein the sensor for detecting electromagnetic waves is a sensor for detecting light waves.

38. The camera assistance system as claimed in claim 15, wherein the sensor for detecting sonic waves is a sensor for detecting ultrasonic waves.
